(19) United States
(12) Patent Application Publication
(10) Pub. No.: US 2025/0196038 A1
(43) Pub. Date: Jun. 19, 2025

(54) METHOD TO FORM A DUST COLLECTING LAYER ON A POROUS BODY WITHOUT USING A BINDER

(71) Applicants: NITTETSU MINING CO., LTD., Tokyo (JP); Herding GmbH Filtertechnik, Amberg (DE)

(72) Inventors: Hiromichi MATSUMOTO, Tokyo (JP); Shinichi OGURA, Tochigi (JP); Yuji NIHEI, Tochigi (JP); Ken SHINODA, Tochigi (JP); Takahiro ITO, Tokyo (JP); Masanori KANEKO, Tochigi (JP); Toru HOSI, Tokyo (JP); Julian RAABE, Amberg (DE); Christoph WEIH, Hirschau (DE); Christian HAMMER, Amberg (DE); Stefan HAJEK, Amberg (DE); Dino BETHKE, Koenigstein (DE); Martina MARX, Illschwang (DE); Urs HERDING, Amberg (DE)

(73) Assignees: NITTETSU MINING CO., LTD., Tokyo (JP); Herding GmbH Filtertechnik, Amberg (DE)

(21) Appl. No.: 19/057,226

(22) Filed: Feb. 19, 2025

Related U.S. Application Data
(63) Continuation-in-part of application No. PCT/JP2023/032092, filed on Sep. 1, 2023.

(30) Foreign Application Priority Data
Sep. 2, 2022 (JP) 2022-140225
Aug. 18, 2023 (JP) 2023-133455

(51) Int. Cl. B01D 46/00; B01D 39/16; B01D 46/02

(52) U.S. Cl. CPC B01D 46/0001; B01D 46/02; B01D 39/1653; B01D 2239/0258; B01D 2239/10

(57) ABSTRACT

The present invention provides a method for producing a filter element that does not have any peeling of fine particles constituting a dust collection layer, and maintains high performance for long periods of time even when scaled up. The method includes depositing to form a layer of fine particles including low melting fine particles and small diameter fine particles, on a surface of a filter element material while suctioning the filter element material, and heating the layer of the fine particles by using a heater such as an infrared heater or an oven to sinter the fine particles to form the dust collection layer.

This application is a continuation-in-part of international application PCT/JP2023/032092 filed on Sep. 1, 2023, and claims priority of Japanese applications 2022-140225 filed on Sep. 2, 2022, and 2023-133455 filed on Aug. 18, 2023, the contents of which are incorporated by reference herein in their entireties.

### TECHNICAL FIELD

The present invention relates to a method for producing a filter having a low pressure loss and high energy efficiency by forming a dust collection layer having a certain strength while having a high collection performance without using any binder. More particularly, the present invention relates to a method for producing a filter that has excellent resistance to pulse air during backwashing and maintains the performance for long periods of time even when scaled up.

### BACKGROUND ART

A filter element of a dust collection filter includes a filter element material made of a resin sintered body and a dust collection layer made of resin fine particles. The filter element of the dust collection filter may also be constituted by adding a carbon layer having conductivity depending on a specification of the filter element.

The filter element material can be obtained by sintering a synthetic resin powder by methods shown in Patent Literatures 1, 2, and so on. Voids through which air can pass are formed between individual particles of the synthetic resin constituting a sintered body of the obtained synthetic resin.

A dust collection layer of a filter element of a sintered lamellar filter is formed as follows. The resin fine particles used as the dust collection layer are suspended in an aqueous solvent. A coating liquid containing the resin fine particles to be used as the dust collection layer are then produced. After applying the coating liquid to the surface of the filter element material made of the resin sintered body, drying the coating liquid to form the dust collection layer.

Furthermore, a filter element for an antistatic specification is formed as follows. A carbon powder having conductivity is suspended in the aqueous solvent. A coating liquid containing the carbon powder having conductivity is produced. After applying the carbon coating liquid to the surface of the filter element material made of the resin sintered body, drying the carbon coating liquid to form a carbon layer having conductivity. Then, after applying the coating liquid containing the resin fine particles to be used as the dust collection layer, drying the coating liquid to form the dust collection layer.

For the fine particles of the resin to be used as the dust collection layer, a material property and particle diameter of the resin are selected depending on a property and particle diameter of dust to be collected by using the dust collection filter. The material property of the resin to be used as the dust collection layer is selected from polyethylene (PE), polytetrafluoroethylene (PTFE), and the like. The particle diameter of the resin is selected from the range between 1-100 μm.

The dust collection layer is formed by individually laminating the fine particles of the resin used for the dust collection layer, and has a structure having voids capable of passing air between the individual resin fine particles constituting the dust collection layer. Dust of dust-containing air containing the particles to be collected is captured with the dust collection layer, and clean air after the dust is collected with the dust collection layer passes through the voids capable of passing air formed in the dust collection layer and the voids of the filter element material, and flows into the inside of the filter element.

Here, a structure of a general dust collector and steps of removing the dust from the dust-containing air will be described with reference to FIG. 1.

A dust collector 10 has a sealed casing 12. The inside of the casing 12 is divided into a lower dust collection chamber 16 and an upper clean air chamber 18 by an upper top panel 14 that is a partition wall. A supply port for dust-containing air 20 communicating with the lower dust collection chamber is disposed on a middle part of the casing. An exhaust port for clean air 22 communicating with the clean air chamber is also disposed on an upper part of the casing. Further, a hollow planar-shaped filter element 24 is secured with a predetermined space on a lower surface of the upper top panel. A hopper 26 for discharging the discarded dust, and an outlet for the dust 28 are disposed on a lower part of the casing.

As shown in a schematic external view in FIG. 1(2), a large diameter part 32 is formed on an upper end of the filter element 24. The large diameter part is formed in an inflated shape so as to accommodate a frame 34. Both ends of the frame accommodated in the large diameter part are secured to the upper top panel 14 integrally with the large diameter part via a fastening bolt 36. Note that a packing 38 is interposed between the upper top panel and the frame.

Further, as a P-P cross-section in the external view of the filter element is shown in a perspective view in (FIG. 1(3)), the inside of the filter element is formed with a plurality of hollow chambers 24a whose upper end is opened. An adhesive surface of the dust of the filter element is in a corrugated sheet shape or a bellows shape, and thus the adhesive surface area is enlarged. The dust-containing air supplied from the supply port for dust-containing air 20 into the dust collection chamber 16 of the casing passes through a filter body of the hollow-shaped filter element, and flows into the inside of the filter element. At this time, a powder to be collected is adhered to and deposited on the dust collection layer formed on the surface of the filter element material to collect. The clean air flowed into the inside of the filter element passes through a passage of the frame, enters the upper clean air chamber 18 of the casing, and is guided to a predetermined location from the exhaust port for the clean air 22.

When the powder to be collected is adhered to and deposited on the dust collection layer formed on the surface of the material of the filter element, the air passage is clogged, thereby increasing the pressure loss. Therefore, the filter element 24 is each sequentially backwashed with a constant time interval so as to remove the powder to be collected adhered to and deposited on the dust collection layer. That is, a backwash valve (not shown) is opened and closed at a constant interval using a timer controller or the like, and pulse air for backwashing is injected from the corresponding injection pipe. Thereby, the pulse air backflows from the inner side of each filter element 24 toward the outer side thereof. As a result, the powder to be collected adhered to and deposited on the dust collection layer is shaken off in a deposited form without being scattered. The powder to be collected that is shaken off is collected from the outlet 28 through the hopper 26.

The filter element is formed by the synergistic effect of the aforementioned device configuration of the dust collector, the removal mechanism for removing the dust from the dust-containing air, and the configuration of the filter element. The filter element includes the filter element material made of the resin sintered body and the dust collection layer made of the resin fine particles. This filter element has been widely employed as a dust collection filter element capable of continuous use over a long period of time, and as an environmental dust collection means at dust-generating sites such as mines, quarries, and ironworks in domestic and overseas.

However, the dust collection layer formed by applying the conventional coating liquid to the surface of the filter element material is adhered to the surface of the filter element material by an adhesive force using a water-soluble binder. The adhesive force cannot be said to have high strength, and therefore there has been a concern that a part of the dust collection layer peels off and contaminates the powder to be collected when the powder to be collected adhered to and deposited on the dust collection layer is removed by backwashing with the pulse air. Therefore, it has not been available for applications such as food where prevention of contamination is important.

Further, the pressure loss per filtration area (initial pressure loss) at the start of operation is slightly larger as compared with a general bag dust collection filter, and thus user's demand for reduction in initial cost has not been satisfied. Under these circumstances, there has been a demand for development of a dust collection layer formed on the surface of the filter element material made of the resin sintered body with being stronger and having the low initial pressure loss.

As a method for solving the above-mentioned technical problems, the present inventors developed a dry method for forming a dust collection layer without using a liquid binder (Patent Literature 3). The use of the filter element produced by this method enabled to efficiently collect the dust having lower in pressure loss as compared with the element in which the dust collection layer is formed by using the liquid binder.

In order to apply this filter element having a low pressure loss to a larger dust collector, the present inventors produced a large filter element by the above-mentioned method for forming the dust collection layer. When a dust collection experiment was conducted by using the larger filter element while backwashing with the pulse air for long-term operation, the desired pressure loss was initially maintained, but the pressure loss was increased with the passage of time.

### CITATION LIST

### Patent Literature

Patent Literature 1: Japanese Unexamined Patent Application Publication No. 2003-126627
Patent Literature 2: Japanese Unexamined Patent Application Publication No. 2004-202326
Patent Literature 3: Japanese Unexamined Patent Application Publication No. 2022-022054

### SUMMARY OF INVENTION

### Technical Problem

An object of the present invention is to provide a method for producing a filter element that forms a dust collection layer on the surface of a filter element material made of a resin sintered body, and that maintains to be strong and have the low initial pressure loss over a long period of time, and is resistant to a scale-up.

### Solution to Problem

The present inventors investigated in detail of the problems at the time of scale-up in the prior art described in Patent Literature 3. As a result, it was found that the increase of the surface area of a filter element material to be heated with scale-up of a filter element causes a temperature variation on the surface of the filter element material at the time of heating and fusion bonding. Further, it was found that particles forming a dust collection layer are completely melted to partially generate pores in a size close to pores of the filter element material on the dust collection layer, thereby causing the increase in pressure loss.

When a part having such pores is generated on the dust collection layer, an excessive air flow is caused in the part, and a powder to be collected is not completely removed by backwashing with pulse air, resulting in reaching at the filter element material. The powder to be collected is accumulated into the filter element material and eventually the pores of the filter element material are blocked. When such a blocked part is increased, the absolute number of pores of the filter element is decreased to increase the air flow per pore. Falling into a vicious cycle that the blocked area is gradually increased from the part having a relatively large pore size leads to the increase in pressure loss.

Furthermore, in the case of backwashing with pulse air necessary for long-term operation is performed intermittently, when the particles constituting the dust collection layer have a larger diameter than that of the powder to be collected, fine particles of the powder to be collected repeatedly break through the dust collection layer. As a result, the fine particles of the powder to be collected deposit into the filter element material, which was found to be one of the causes of the increase in pressure loss.

In light of the above problems, the present inventors further repeated trial and error of a method for forming the dust collection layer. As a result, it has been found that mixing low melting particles with some of the particles forming the dust collection layer, and setting a heating temperature used to form the dust collection layer to a temperature equal to or higher than a melting point of the low melting particles and lower than a melting point of the particles of the filter element material and a melting point of other fine particles forming the dust collection layer. This has been found that even if there are slight temperature variations in different parts of the filter element material, the use of the low melting particles ensures to perform the fusion bonding of the particles forming the dust collection layer together. Furthermore, it has been found that the mixture of the fine particles with the particles forming the dust collection layer allows to reduce the number of fine powders to be collected that break through the dust collection layer during the backwashing with pulse air. This led to the present invention.

Therefore, embodiments according to the present invention are as follows.

(1) A method for producing a filter element, including: forming a layer made of a plurality of kinds of fine particles on a surface of a filter element material, one or more kinds of the plurality of kinds of fine particles having a melting point lower than a melting point of the filter element material and fine particles forming a dust collection layer; and heating the layer of the fine particles by using a heating means to sinter the fine particles to form the dust collection layer.

(2) The method for producing a filter element according to (1), wherein a particle diameter of one or more kinds of fine particles of the plurality of kinds of fine particles is smaller than a particle diameter of the filter element material.

(3) The method for producing a filter element according to (1) or (2), wherein one or more kinds of fine particles forming the dust collection layer of the plurality of kinds of fine particles are fine particles smaller than a pore of the filter element material.

(4) The method for producing a filter element according to any one of (1) to (3), wherein two or more kinds of fine particles according to (1) are sufficiently mixed in advance and then sucked on a filter element material to form the filter element on a surface of the filter element material.

(5) The method for producing a filter element according to any one of (1) to (4), wherein two or more kinds of fine particles according to (1) are separately sucked on a filter element material to form the filter element in a layered form on a surface of the filter element material.

(6) The method for producing a filter element according to any one of (1) to (5), wherein the heating means includes an infrared heater or oven.

(7) The method for producing a filter element (204) according to any one of (1) to (6), wherein the filter element (204) includes at least one pocket-like or bag-like structure (310); the at least one pocket-like or bag-like structure (310) has an internal space (208) enclosed by at least one wall (210) of the filter element (204), leaving at least one clean fluid outlet opening (212); the filter element (204) has an inner surface facing the internal space (208) and an outer surface oriented in an opposite direction to the internal space (208); and a dust collection layer is formed on the outer surface of the filter element (204).

(8) The method for producing a filter element (204) according to any one of (1) to (6), wherein the filter element (204) includes at least one pocket-like or bag-like structure (310); the at least one pocket-like or bag-like structure (310) has an internal space (208) enclosed by at least one wall (210) of the filter element (204), leaving at least one unprocessed fluid inlet opening (228); the filter element (204) has an inner surface facing the internal space (208) and an outer surface facing in an opposite direction to the internal space (208); and a dust collection layer (202) is formed on the inner surface of the filter element (204).

(9) The method for producing a filter element (204) according to any one of (1) to (8), wherein the filter element (204) is formed with at least one filter element wall (210) defining a lamellar structure (300); and the lamellar structure (300) includes a geometric configuration having a convex portion (304) and a concave portion (306) on at least one of two opposite sides of the at least one filter element wall (210).

(10) The method for producing a filter element (204) according to (9), wherein the geometric configuration includes a plurality of convex portions (304) and concave portions (306) on both sides of the at least one filter element wall (210).

(11) The method for producing a filter element (204) according to (9) or (10), wherein the convex portion (304) and the concave portion (306) of the at least one filter element wall (210) are shaped to form at least one undercut portion (308) of the geometric configuration.

(12) The method for producing a filter element (204) according to any one of (9) to (11), wherein the geometric configuration of the lamellar structure includes a helical structure (302).

(13) The method for producing a filter element (204) according to any one of (9) to (12), wherein the filter element (204) is formed with at least one pocket-like or bag-like structure (310) having a cylindrical, conical, or other rotational symmetric shape defined by the at least one filter element wall (210); and the convex portion (304) and the concave portion (306) of the at least one filter element wall (310) are shaped to form the geometric configuration of the lamellar structure (300).

(14) The method for producing a filter element (204) according to any one of (9) to (13), wherein one of the two or more kinds of fine particles constitutes a matrix material of the dust collection layer (202) and is made of the same resin material as the filter element material.

(15) The method for producing a filter element (204) according to (14), wherein the one of the two kinds of fine particles constituting the matrix material of the dust collection layer (202) includes polyethylene.

(16) The method for producing a filter element (204) according to any one of (1) to (15), wherein the dust collection layer (202) is formed without using any binder or solvents.

(17) The method for producing a filter element (204) according to any one of (1) to (16), wherein the two or more kinds of fine particles do not include perfluoroalkoxy alkane (PFA).

(18) A filter element (204) produced by using the method according to any one of (1) to (17).

Examples of the heating means for heating the layer of the fine particles include a heating means for irradiating with heat rays and a heating means for heating under a high temperature atmosphere. An example of the heating means for irradiating with heat rays includes an infrared heater, and an example of the heating means for heating under a high temperature atmosphere includes a gear oven.

The particle diameter of a resin fine powder used for the dust collection layer can be selected from the range between 0.1-200 μm, and preferably a resin fine powder having an average particle diameter of 0.1 μm-50 μm is used. The average particle diameter described herein refers to as a D50 value when measured with a particle size distribution measuring apparatus such as Microtrac.

In addition to PTFE fine particles, ultra-high molecular weight polyethylene (manufactured by Celanese Japan Limited, GUR2126) or low molecular weight polyethylene (manufactured by Mitsui Fine Chemicals, Inc., Hi-WAX HP10A) is preferably used as the resin fine powder forming the dust collection layer.

Further, the temperature difference between a melting point of the resin fine powder having a low melting point and a melting point of other fine particles forming the dust collection layer may be equal to or higher than the temperature variations inevitably caused by the heating means to be used. For example, low melting point resin such as low molecular weight polyethylene may be used as low melting point fine particles.

Furthermore, particles having a small diameter of the fine particles forming the dust collection layer can use high-density polymers such as HDPE.

In the formation of the dust collection layer, the adhesion amount of a fine particle group adhered to the surface of the filter element material can be appropriately specified from the range between 1 g-100 g/m², and more preferably, in the range between 30 g-60 g/m².

When the amount of the fine particle group to be adhered on the surface of the filter element material is small, the fine particle group do not spread over the entire surface and the pores of a sintered body are not sufficiently filled. When the amount of the fine particle group is excessive, lumps are formed in the surface layer, causing the increase in initial pressure loss.

For example, the application by using a brush is a simple method for adhering the fine particle group to the surface of the filter element material.

A method for adhering the fine particle group forming the dust collection layer to the surface of the filter element material uses a jig in FIG. 3.

A material of a 2-core element is installed in the jig in FIG. 3. The fine particle group forming the dust collection layer is placed at the bottom of the jig, and compressor air is blown from a compressed air blowoff port 92 at the bottom of the jig while sucking by using a ring blower disposed in communication with the jig through a pipe. The particles are blown up, thereby sufficiently spreading in the pores on the surface of the filter element material. The fine particle group forming the dust collection layer are all mixed or each fine particle group is adhered in stages in a layered form without mixing.

A method for securing the fine particle group adhered to the surface of the filter element material as the dust collection layer uses the heating means as shown in the oven in FIG. 2. The fine particle group is heated to a softening point of the particles having the lowest softening point among the fine particle group to melt the fine particle group, and the surface of the filter element material and the fine particle group are fusion bonded or the fine particle group is fusion bonded to each other to complete the method.

The dust collection layer as shown in FIG. 5 is formed on the surface of the completed filter element material. This is achieved by filling the pores of the filter element material with the adhered fine particle group, and then the fine particles that do not melt by heating retain their particle form, thereby forming the dust collection layer having extremely fine pores. This achieves both to maintain the dust collection performance to suppress the initial pressure loss.

Note that the 2-core element refers to as a testing filter of a filter element in an aspect as shown in FIG. 4. The 2-core element has a structure with two sets of hollow chambers (cores) whose upper ends are open inside the filter element material, and is an element material obtained by integral sintering, or by gluing a member constituting the element together with an adhesive or the like to produce.

The above-mentioned method can be applied to form a dust collection layer on a filter element that has at least one pocket-like or bag-like structure. The feature of the pocket-like or bag-like structure is to form an internal space enclosed by at least one wall.

At least one wall has an opening that allows access to the internal space of the pocket-like or bag-like structure from the outside in order to put substances into the internal space or take them out of the internal space.

At least one pocket-like or bag-like structure may have at least one clean fluid outlet opening, and have a pocket or bag shape defining the internal space enclosed by at least one wall of the filter element. That is, except for one or more clean fluid discharge openings, the internal space of the pocket-like or bag-like structure is enclosed by at least one filter element wall.

Such a filter element has an inner surface facing the internal space of the pocket-like or bag-like structure.

Such a filter element also has an outer surface facing in the opposite direction to the internal space of the pocket-like or bag-like structure.

When utilizing such a filter element, the method for forming the dust collection layer described herein would include forming the dust collection layer on the outer surface of the pocket-like or bag-like structure.

According to this method, the particles forming the dust collection layer are adhered to the surface of at least one wall of the filter element facing in the opposite direction to the internal space.

Importantly, the dust collection layer is also applicable to the filter element having a configuration with the pocket-like or bag-like structure.

In other words, when the filter element having the pocket-like or bag-like structure is formed before assembly, it is not necessary to assemble two or more parts of the filter elements with the laminated separate dust collection layers to form the filter element.

Rather, according to the method described herein, the dust collection layer can be applied to the filter element in a more precise manner, in the form of the pocket-like or bag-like structure that has already been formed, on the outside of the pocket-like or bag-like structure.

Alternatively or additionally, at least one pocket-like or bag-like structure may have a pocket or bag shape that defines an internal space closed by at least one wall of the filter element, while leaving at least one raw material fluid inlet opening.

In other words, except for one or more raw material fluid inlet openings, the internal space of the pocket-like or bag-like structure is enclosed by at least one filter element wall.

Such a filter element has an inner surface facing the internal space of the pocket-like or bag-like structure.

Such a filter element also has an outer surface facing in the opposite direction to the internal space of the pocket-like or bag-like structure.

When utilizing such a filter element, the method for forming the dust collection layer described herein would include forming the dust collection layer on the inside of the pocket-like or bag-like structure.

In this way, the particles forming the dust collection layer are adhered to the surface of at least one wall of the filter element facing the internal space.

Importantly, the dust collection layer can be applied to the filter element having a structure in which the pocket-like or bag-like structure has already been formed.

Note that when the filter element having the pocket-like or bag-like structure is formed before assembly, it is not necessary to assemble two or more components of the filter element with the separate dust collection layer to form the filter element.

Rather, according to the method described herein, the dust collection layer can be formed on the surface of the filter element material in a more precise manner, in the form of the pocket-like or bag-like structure that has already been formed, on the inside of the pocket-like or bag-like structure.

Furthermore, the above-mentioned method may be applied to form the dust collection layer on the surface of the filter element material that forms at least one filter element wall defining a lamellar structure.

The lamella structure has a geometric configuration having a convex portion and a concave portion on at least one of two opposite sides of at least one filter element wall.

In particular, at least one filter element wall defining the lamella structure may be the same filter element wall as at least one filter element wall defining the pocket-like or bag-like structure.

In particular, the geometric configuration can be configured to include a plurality of convex and concave portions on both sides of the filter element wall.

In particular, the convex and concave portions of at least one filter element wall may be shaped to form at least one undercut portion of the geometric configuration.

Conventional coating methods such as spraying and brushing could not have achieved to apply the dust collection layer as a coating film sufficiently and uniformly to the surface of the filter element wall forming the undercut portion. As a result, it is not possible to prevent the remaining uncoated areas or areas with poor coating efficiency in the undercut pores.

The adhesion of two or more kinds of fine particles in a powder form to the filter element and then only melting one of the two or more kinds of fine particles enable to obtain the dust collection material with a sufficiently uniform thickness. This special technique makes it possible to form the dust collection layer even in an area where the undercut portion is formed.

In a certain example of the method for producing the filter element as described herein, the geometric configuration of the lamellar structure includes a helical structure.

The application of the helical structure allows the filter element with a given volume to produce a lamellar structure having a large surface area available for filtering.

For example, in the case of the filter element with the pocket-like or bag-like structure, the area of the filter surface per unit of the internal space enclosed by the filter element wall would be particularly large.

This increases the filter efficiency per volume required by the filter element.

In particular, the filter element can be formed with at least one pocket-like or bag-like structure having a cylindrical, conical, or other rotationally symmetric shape.

The pocket-like or bag-like structure having a cylindrical or conical shape is rotationally symmetric about a longitudinal axis of the cylinder or cone.

Instead of the cylindrical or conical shape, any other shapes having the same rotational symmetry about the longitudinal axis may be used.

The shape of the filter element is defined by at least one filter element wall.

The convex and concave portions of at least one filter element wall are shaped to form the geometric configuration of the lamellar structure.

In particular, the lamellar structure having the helical geometric shape is well suitable for the pocket-like or a bag-like structure having the cylindrical or conical shape.

In a particularly preferred example, the use of the method for producing a filter element described herein enables one of two or more kinds of fine particles constituting a matrix material of the dust collection layer to use the same resin material as the filter element material to be adhered.

In this way, the material used to form a body of the filter element (e.g., sintered polyethylene material) can also produce an approximately uniform filter element, which forms the matrix of the dust collection layer.

In this context, the term “matrix of the dust collection layer” refers to as a material or fine particles constituting the structure of the dust collection layer, rather than any other materials such as additives or a filler added to the matrix.

In one example, one of two kinds of fine particles constituting the matrix material of the dust collection layer may include polyethylene.

In particular, in the method for producing a filter element described herein, the dust collection layer can be formed without using any binder or solvents.

In particular, the method for producing a filter element described herein can be referred to as a dry coating method or a powder coating method.

In other words, one or more kinds of fine particles of the dust collection layer may be adhered to the surface of the filter element material in a powder form, either in a mixture of one or more kinds of fine particles that are pre-mixed, or by adhering different kinds of fine particles sequentially.

In this process, any liquid binder or solvents are not used.

Rather, at least one of the one or more kinds of fine particles is melted by heating after the fine particles are made into a powder form and adhered to the surface of the filter element material.

This allows properties of the dust collection layer to be adjusted much better than the conventional liquid-based coating method.

In particular, the one or more kinds of fine particles in a powder form are applied to the surface of the filter element in combination with the use of the fluidized bed technique described herein, allowing to coat with high quality even a layered structure including a complex geometry shape such as the undercut portion.

In addition, in the method for producing a filter element described herein, the formation of the dust collection layer is not required to use perfluoro-alkoxyalkane (PFA).

Therefore, in a specific example, the two or more kinds of fine particles forming the dust collection layer do not include PFA, and more particularly, the two or more kinds of fine particles do not contain polytetrafluoroethylene.

As described herein, the filter element that does not completely include PFA can be obtained by using the method for forming and adhering the dust collection layer on the surface of the filter element material without including any binder or solvents. This filter element can be cleaned sufficiently and effectively over a long period of time by means of pressure pulse.

As the inventors have found, the pressure loss of the fluid passing through the filter element based on the present invention after a pressure cleaning cycle is initially relatively low and remains at a fairly low and stable level even after the service life of the filter element is extended.

The present invention relates to a filter element produced by the method, in addition to the method for producing a filter element described above.

### Advantageous Effects of Invention

A dust collection layer formed according to the technique of the present invention is firmly fusion bonded to a filter element material as compared with the conventional technique. Therefore, it is possible to clean the filter element by using air blowing or high-pressure water, and it is also possible to prevent contamination to a dust collection powder of fine particles constituting the dust collection layer.

The adjustment of the particle size of the fine particles constituting the dust collection layer to be adhered to the surface of the filter element material allows to adjust the size of a pore in the dust collection layer. It is also possible to change the performance of the dust collection layer by pre-mixing other particles with the fine particles to be adhered.

This enables the present invention to provide a filter having the pore diameter that are sufficient for the required performance such as a low pressure loss, to users. Furthermore, it can be expected to prevent contamination to the dust collection powder, and to contribute to the development of new applications or the efficiency of dust collector maintenance and the improvement of productivity.

The above-mentioned method can be applied to form a dust collection layer on the surface of the filter element material having at least one pocket-like or bag-like structure.

The dust collection layer can be formed on the surface of the filter element material in a configuration in which the pocket-like or a bag-like structure has already been formed.

This dust collection layer can be formed on an outside of the pocket-like or the bag-like structure, on an inside of the pocket-like or the bag-like structure, or on both sides of the pocket-like or the bag-like structure, in a state where the pocket-like or a bag-like structure has already been formed.

A specific advantage according to the method of the present invention is that it is possible to form the sufficiently uniform dust collection layer on the surface of the filter element material, even when the surface has a surface shape forming an undercut.

Furthermore, the same material as used for forming the filter element material, for example polyethylene, can be used for forming a matrix of the dust collection layer.

### BRIEF DESCRIPTION OF DRAWINGS

FIG. 1 (1) is an external view of a general dust collector.

FIG. 1 (2) is an external view of a filter element (sintered-lamellar).

FIG. 1 (3) is a perspective view of a P-P cross section.

FIG. 2 is a heating means (oven).

FIG. 3 is a cross-sectional view of a jig for suction of a filter element material.

FIG. 4 is a photograph of a material of a 2-core element.

FIG. 5 is a cross-sectional image of an example.

FIG. 6 is a laboratory load testing device for a 2-core element.

FIG. 7 is a load testing device for a filter element in actual production size.

FIG. 8 is a graph illustrating the change in pressure loss of a filter element over time in actual production size, together with experimental results for conventional examples.

FIG. 9 shows a schematic view of a processing box body configured to form a dust collection layer on an outside of a pocket-shaped or bag-shaped filter element material, according to a further embodiment.

FIG. 10 shows a schematic cross-sectional view of a filter element produced by using the processing box body shown in FIG. 9.

FIG. 11 shows a schematic cross-sectional view of a processing box body configured to form a dust collection layer on an inside of a pocket-shaped or bag-shaped filter element material, according to a further embodiment.

FIG. 12 shows a schematic cross-sectional view of a filter element produced by using the processing box body shown in FIG. 11.

FIG. 13 shows a schematic view of a processing box body configured to form a dust collection layer on an inside of a pocket shaped or bag-shaped filter element material, according to a further embodiment.

FIG. 14 shows a different view of a filter element material in which a dust collection layer can be formed on an inside or outside of the filter element material, according to any one of embodiments of the present invention.

FIG. 15 shows a different view of a further filter element material in which a dust collection layer can be formed on an inside or outside of the filter element material, according to any one of embodiments of the present invention.

FIG. 16 shows a graph illustrating the change in pressure loss of the filter element over time in Example 9.

### DESCRIPTION OF EMBODIMENTS

Hereinafter, the present invention will be described in detail based on examples of the present invention. However, the present invention is not limited to the following examples.

Moreover, a filter element used in the examples and comparative examples of the present invention includes a 2-core integrated element. The 2-core integrated element is a filter element for a scale-up testing having a structure with two sets of hollow chambers inside the filter element. The 2-core integrated element is obtained by forming a dust collection layer according to the present invention on an element material obtained by integrally sintering.

### Example 1

A material of a 2-core element was placed in a jig for suction in FIG. 3. Mixed particles of 5 g were placed at the bottom of the jig, with a weight ratio of LLDPE (linear low molecular weight PE, D50=45 μm): HDPE (high density PE, D50=10 μm): PTFE (D50=3.7 μm)=5:4:1. A ring blower disposed in communication with the jig through a pipe was used to blow compressed air from the compressed air blowoff port 92 at the bottom of the jig while suctioning at a filtration air velocity of 2.0 m/min. The mixed particles were then blown up, allowing them to sufficiently spread out over pores on the surface of the filter element material.

A gear oven (ACR45A, manufactured by Toyo Seiki Seisaku-sho, Ltd.) was used to perform the heating and fusion bonding at an ambient temperature of 130° C. for 30 min to produce a 2-core filter element (filtration area 0.16 m²) with a dust collection layer.

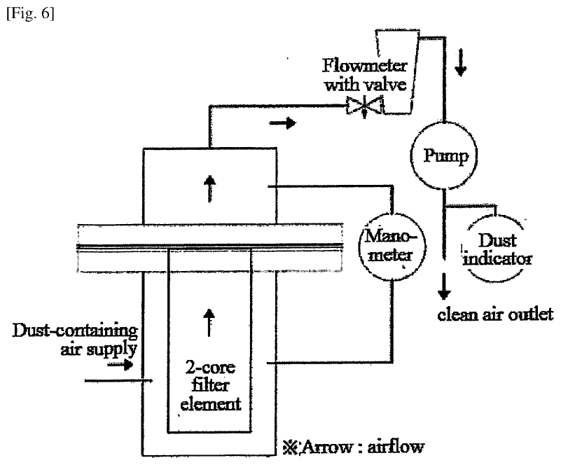

The 2-core element obtained above was secured to a laboratory dust collection load testing device for the 2-core element (FIG. 6, manufactured by Nittetsu Mining Co., Ltd.). As an experimental dust collection powder, calcium carbonate powder for flue gas desulfurization (average particle diameter: 12 μm, manufactured by Nittetsu Mining Co., Ltd.) was used to perform a dust collection load confirmation test for 5 minutes under a filtration air velocity of 1 m/min (processing air volume of 0.16 m³/min), and a dust feed concentration of (10 g/m³). In the dust collection load confirmation test, the pressure loss (kPa) and dust-containing concentration in exhaust air (LD-3K2, manufactured by SIBATA SCIENTIFIC TECHNOLOGY LTD.) at the start and end of the test were evaluated.

The obtained results are shown in the table together with an result of a similar experiment using a filter element made of a classification product (D50=24 μm) of low molecular weight polyethylene powder (manufactured by Mitsui Fine Chemicals, Inc., Hi-WAX HP10A) used in Example 8 in Patent Literature 3.

Although the pressure loss of the filter element in the Example 1 was slightly higher than that in Patent Literature 3 (Example 8), the dust-containing concentration in exhaust air was significantly lower than that in Patent Literature 3 (Example 8).

### Example 2

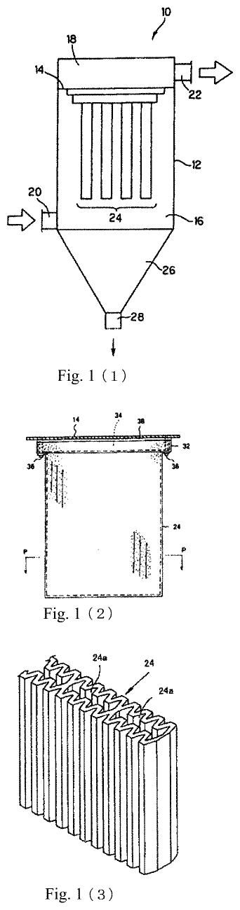

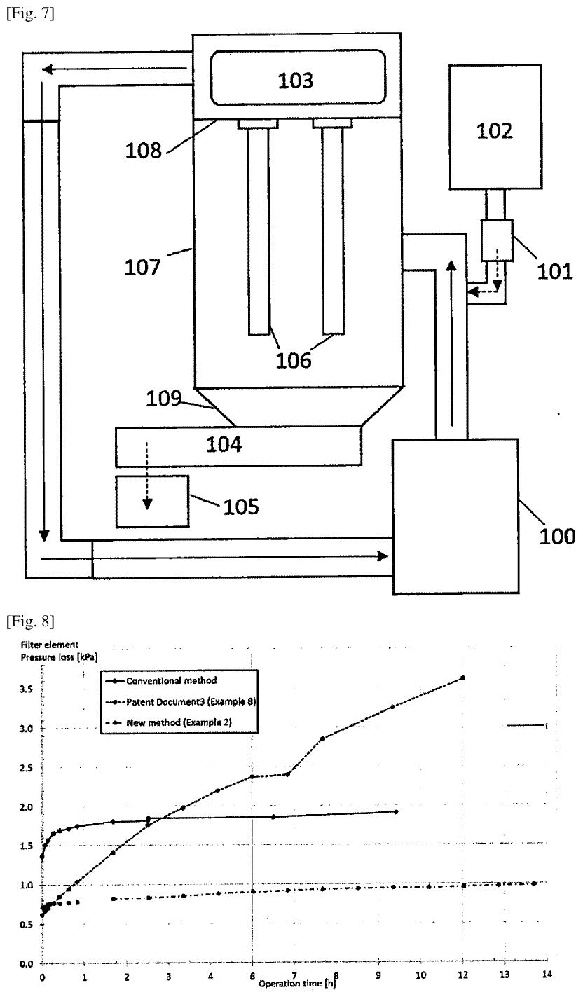

The filter element in actual production size produced above was secured to a load test device for a filter element in actual production size (FIG. 7: manufactured by Nittetsu Mining Co., Ltd.), and a dust collection load confirmation test was conducted. The structure of the load test device for a filter element in actual production size is the same as the general dust collector in FIG. 1, with the inside of the sealed casing divided into an upper clean air chamber 103 and a lower dust collection chamber 107 by an upper top plate 108 that is a partition wall.

Calcium carbonate powder for flue gas desulfurization (average particle diameter: 12 μm, manufactured by Nittetsu Mining Co., Ltd.) was used for the experimental dust collection powder. The experimental dust collection powder was extracted by a quantitative supply device 101 installed downstream of an upper tank 102 to achieve the predetermined dust content. The experimental dust powder became dust-containing air in the pipe to flow into the dust collection chamber under the conditions of a filtration air velocity of 1 m/min (processing air volume of 18 m³/min) and a dust feed concentration of 5 g/m³. The dust-containing air was separated into dust and air by a testing filter element 106, which was secured in the dust collection chamber at a specified interval and numbers.

The dust collected by adhering to and depositing in the dust collection layer formed on the surface of the filter element material was discharged to a hopper 109 below the dust collection chamber at one-minute intervals by backwashing pulse air at 0.5 MPa, and stored in a lower tank 105 by using a dust conveyance device 104. The experimental dust powder stored in the lower tank was conveyed to the upper tank by an air transport device (not shown).

In the dust collection load confirmation test, the pressure loss (kPa) and the dust-containing concentration in exhaust air (LD-3K2, manufactured by SIBATA SCIENTIFIC TECHNOLOGY LTD.) at the start and end of the test were evaluated.

The test results are shown in FIG. 8.

From the graph in FIG. 8, it was found that the initial pressure loss of the filter element produced in Example 2 was slightly higher than that in Patent Literature 3 (Example 8); however, this quickly reversed, and the pressure loss of the filter element in Example 2 remained significantly lower as compared with the dust collection layer produced by the conventional technology.

This can be considered as follows. Under the conditions in Patent Literature 3 (Example 8), low-molecular-weight PE fine particles was melted, and the large-diameter particles that approximately left undissolved acted the formation of the pores of the dust collection layer. On the other hand, the dust collection layer produced in Example 2 is formed by a mixture of three kinds of fine particles, two of which is a mixture of fine particles that do not melt at the heating temperature, as well as the fine particles that do not melt by heating contribute to the formation of extremely fine pores. Thus, it is considered to be due to the formation of the dust collection layer that has fewer large pores causing blockages, although it has the high initial pressure loss.

### Example 3

A material of a 2-core element was installed in the jig for suction in FIG. 3. Powders of LLDPE, HDPE, and PTFE were each placed separately at the bottom of the jig, and the ring blower disposed in communication with the jig through the pipe was used to blow compressed air from the compressed air blowoff port 92 at the bottom of the jig while suctioning at a filtration air velocity of 2.0 m/min. The mixed particles were then blown up, allowing them to sufficiently spread out over the pores on the surface of the filter element material. Specifically, the particles were each adhered to the surface of the element material in the following order: HDPE (D50=120 μm), LLDPE (D50=20 μm), HDPE (D50=10 μm), LLDPE (D50=20 μm), and PTFE (D50=3.7 μm). After removing them from the jig, the gear oven (ACR45A, manufactured by Toyo Seiki Seisaku-sho, Ltd.) was used to perform the heating and fusion bonding at an ambient temperature of 130° C. for 30 minutes to produce the 2-core element with the dust collection layer.

The 2-core element obtained above was secured to the laboratory dust collection load testing device for the 2-core element (FIG. 6, manufactured by Nittetsu Mining Co., Ltd.). Calcium carbonate powder for flue gas desulfurization (average particle diameter: 12 μm, manufactured by Nittetsu Mining Co., Ltd.) was used for an experimental dust collection powder to perform a dust collection load confirmation test for 5 minutes under the conditions of a filtration air velocity of 1 m/min (processing air volume of 0.16 m³/min) and a dust feed concentration of 10 g/m³. In the dust collection load confirmation test, the pressure loss (kPa) and the dust-containing concentration in the exhaust air (LD-3K2, Shibata Scientific Instruments) at the start and end of the test were evaluated.

As is clear from the results shown in the table, in Example 3, it was possible to achieve a lower pressure loss while maintaining the collection performance in Example 1.

### Table 1

TABLE

| | | | Exhaust dust concentration | |
|---|---|---|---|---|
| | Pressure loss [kPa] | | [g/m³] | |
| | Test start | End of test | Test start | End of test |
| Patent Document 3 | 0.20 | 0.25 | 67 | 34 |
| Example 1 | 0.29 | 0.36 | 28 | 4 |
| Example 3 | 0.25 | 0.30 | 15 | 5 |

### Example 4

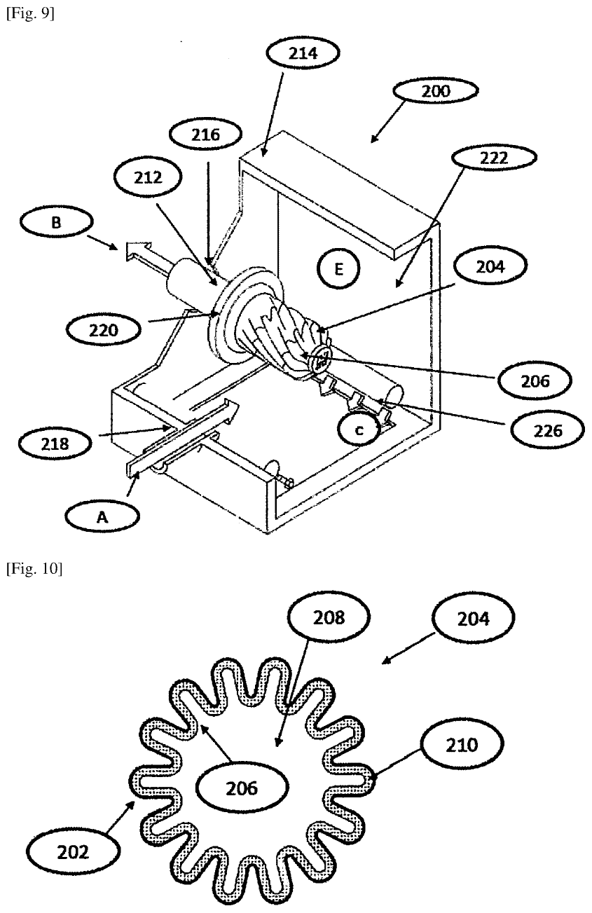

FIG. 9 shows a schematic view of a processing box body 200 configured to form a dust collection layer 202 on an outside of a pocket-like filter element material 206, according to a further example.

The processing box body 200 has a processing box body housing 214 that completely encloses a processing space 222.

The processing box body housing 214 has an inlet opening 218 through which an aerosol including a carrier fluid and a powder mixture (i.e., a mixture of two or more kinds of fine particles dispersed in the carrier fluid) can enter the processing space 222 (see arrow A).

The processing box body housing 214 further has a mounting hole 216 configured to insert and mount a mounting flange 220.

The filter element material 206 of a filter element 204 including the dust collection layer 202 is fitted to the mounting flange 220.

In FIG. 9, the processing box body housing 214 is drawn in a partially cut-out configuration to better show the processing space 222 including the mounting flange 220 and the filter element material 206.

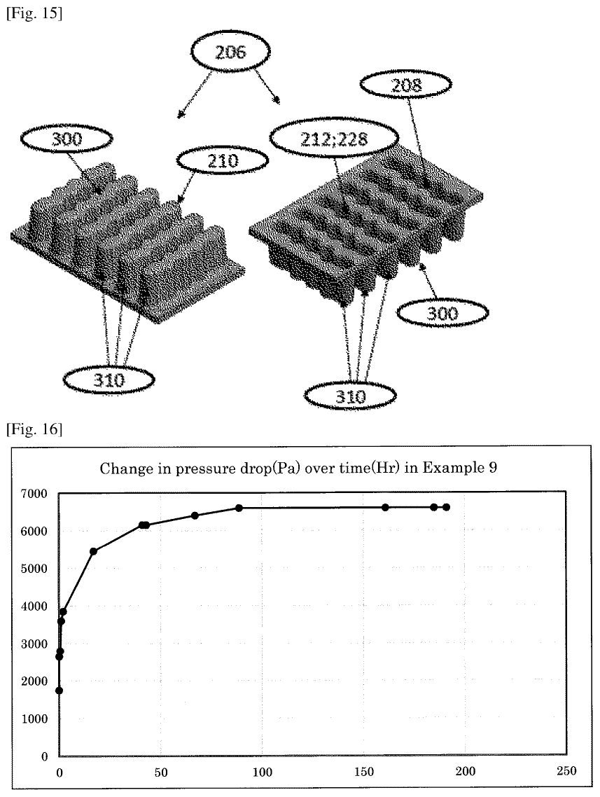

The filter element material 206, and thus the filter element 204 is also formed with at least one pocket-like or bag-like structure 310 having a pocket or bag shape (see FIGS. 14 and 15).

The pocket-like or bag-like structure 310 defines an internal space 208 of the filter element material 206 or the filter element 204.

The internal space 208 is enclosed by at least one filter element wall 210 (see FIG. 10).

At least one filter element wall 210 completely encloses the internal space 208, except for at least one clean fluid outlet opening 212.

Therefore, the filter element 204 has an inner surface facing the internal space 208 and an outer surface facing in the opposite direction to the internal space 208.

When the filter element wall 210 is made of a porous material (e.g., porous polyethylene), fluid (e.g., gas or air) enters the internal space 208 of the filter element 204 through the filter element wall 210 and flows out of the internal space 208 through the clean fluid outlet opening 212.

However, a powder material (i.e., one or more kinds of fine particles dispersed in the carrier fluid injected through the inlet opening 218) cannot pass through the filter element wall 210.

The filter element material 206 provided with the mounting flange 220 is inserted into the mounting hole 216. At that time, a closed side of the filter element material 206 is extended into the processing space 222, and the clean fluid outlet 212 of the filter element 204 is mounted so that it opens toward the outside of the processing box body housing 214.

The mounting flange 220 provided with the filter element body is inserted into and mounted to the mounting hole 216 as described below.

As shown in FIG. 9, the mounting hole 216 and the mounting flange 220, and the mounting flange 220 and the filter element wall 210 fluid seal the processing space 222 against the environment of the processing box body housing 214. For a seal means, a seal means that is outside the scope of common engineering practice, for example a seal ring can also be used.

Therefore, in a configuration shown in FIG. 9, fluid can only flow out of the processing space 222 through the clean fluid outlet 212 of the filter element 204, as indicated by the arrow B in FIG. 9.

Due to the orientation of the filter element 204 and the mounting flange 220 shown in FIG. 9, the powder material cannot enter the internal space 208 of the filter element material 206. Rather, the powder material is adhered to the outside of the filter element material 206 to form the dust collection layer 202 on the outside of the filter element 204.

Therefore, in the processing box body 200 in FIG. 9, the pocket-shaped or bag-shaped filter element 204 is inserted into the processing box body 200 with the outer surface of the filter element 204 exposed to the processing space 222.

Therefore, the processing box body 200 in FIG. 9 is configured to form the dust collection layer 202 on the outer surface of the pocket-like filter element 204.

FIG. 10 shows a schematic cross-sectional view of the filter element 204 produced by using the processing box body in FIG. 9.

A process of forming the dust collection layer 202 on the outside of the pocket-like filter element 204 proceeds as the following steps:

(i) An aerosol fluid of a mixture powder material of two or more kinds of fine particles constituting the dust collection layer dispersed in pressurized carrier fluid (e.g., air) is injected into the processing space 222 through an inlet opening 218 (see arrow A in FIG. 9).

(ii) The clean fluid outlet 212 of the filter element material 206 is coupled to a fan, a blower, a pump, or a similar device. The clean fluid outlet 212 sucks a fluid flow (e.g., air) that passes through the filter element wall 210 from the processing space 222 and does not contain any more powder materials.

Rather, the powder material is applied to the outer surface of the filter element material 206 when the fluid injected into the processing space passes through the processing space 222 through the filter element wall 210.

(iii) The aerosol in the processing space 222 is sucked in by the fan, the blower, or the pump coupled to the clean fluid outlet 212 of the filter element 204 (see arrow B in FIG. 9). Due to this suction action, the powder mixture dispersed in the carrier fluid in the processing space 222 adheres to the outer surface of the filter element material 206 (more precisely, the outer surface of the filter element wall 210 facing the processing space 222).

The adhesion of the powder material to the filter element material 206 helps to form the dust collection layer 202 on the outer surface of the filter element 204.

(iv) The processing box body 200 is provided with a nozzle device 226 with at least one conduit including a plurality of nozzles.

Fluid pulses are injected into the processing space 222 through the nozzle device 226 (see arrow C in FIG. 9).

These fluid pulses further help to maintain a well-dispersed and uniformly mixed state of the aerosol of the powder mixture dispersed in the carrier fluid in the processing space 222 until the application of the material for the dust collection layer 202 is completed.

The installation of such a nozzle device 226 is optional.

This process enables to provide a uniform distribution of the powder material on the surface of the filter element wall 210, even when the filter element wall 210 has a complex surface shape, for example, when the filter element wall 210 has an undercut portion.

For example, in the example of the filter element material 206 shown in FIGS. 14 and 15, the filter element wall 210 forming the filter element material 206 includes a lamellar structure 300 having a complex surface shape including a helical structure 302 of a convex portion 304 and a concave portion 306.

The convex portion 304 and the concave portion 306 form the undercut portion on the outside of the filter element material 206.

The convex portion 304 and the concave portion 306 also form the undercut portion on the inside of the filter element material 206.

The rotation of the filter element 204 in the processing box body 200 is an optional means.

As a result, in the method described above, a process such as a filtration is utilized to adhere the powder mixture in order to form the dust collection layer 202 to the outer surface of the filter element 204.

After the powder mixture for forming the dust collection layer 202 is adhered to the outer surface of the filter element 204, the filter element 204 is removed from the processing box body 200 and a thermal treatment is subjected as described with reference to the above examples.

This thermal treatment causes one of the two or more kinds of particles contained in the powder mixture applied to the surface of the filter element material 206 to melt, and the dust collection layer 202 to adhere to the filter element material 206 after the thermal treatment is completed.

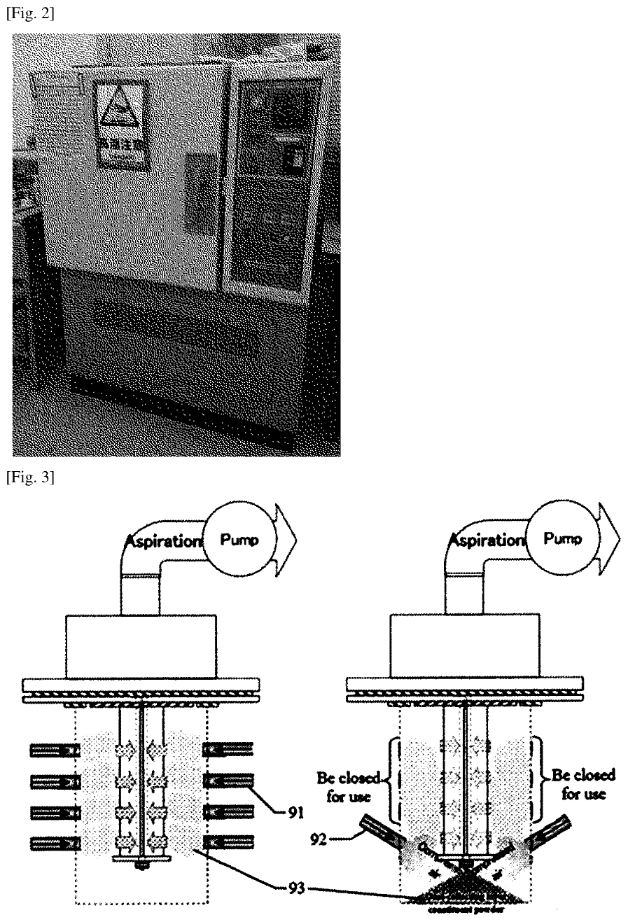

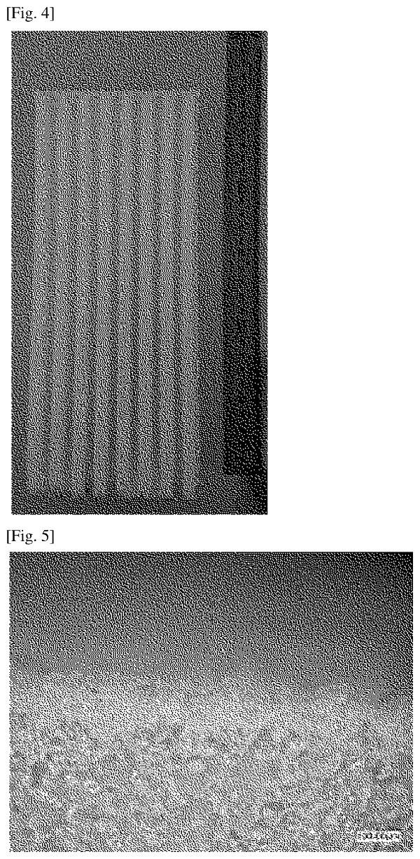

It will be appreciated that more details about the thermal treatment are referred to FIG. 2 and the descriptions, as well as the above-mentioned Example 1.

### Example 5

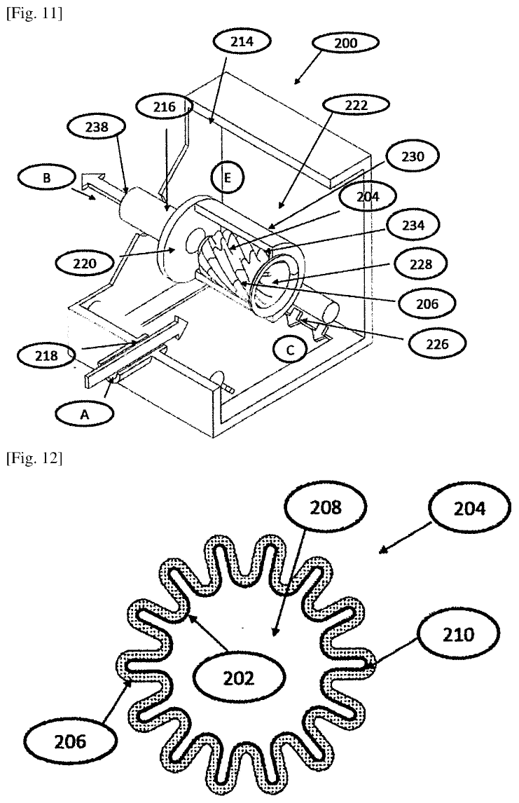

FIG. 11 shows a schematic view of the processing box body 200 configured to form the dust collection layer 202 on the pocket-like filter element 204 on the inside thereof, according to a further example.

FIG. 12 shows a schematic cross-sectional view of the filter element produced by using the processing box body in FIG. 11.

The processing box body in FIG. 11 basically corresponds to the processing box body in FIG. 9.

Therefore, the same reference numbers as those shown in FIG. 9 are also used in FIG. 11.

It will be appreciated that components in FIG. 11 that have the same reference numbers as those in FIG. 9 are referred to the above description in FIG. 9 unless otherwise specified.

The differences between the examples in FIG. 9 and FIG. 11 will be described below.

As the same in FIG. 9, the processing box body housing 214 has the mounting hole 216 configured to insert and mount the mounting flange 220.

The filter element material 206 including the dust collection layer 202 is mounted to the mounting flange 220.

In FIG. 11, the processing box body housing 214 is drawn partially cut away to better show the processing space 222 provided with the mounting flange 220 and the filter element material 206 therein.

In order to form the dust collection layer 202 on the inside of the pocket-like or bag-like filter element 204, the configuration of the mounting flange 220 is changed with respect to FIG. 9, and the pocket-like or bag-like filter element material 206 is mounted to the mounting flange 220 in a different way.

Unlike the mounting flange 220 in FIG. 9, the mounting flange 220 in FIG. 11 includes an additional mounting flange receiver 230.

The mounting flange receiver 230 provides an extension of the mounting flange 220 to the processing box body 222 and is configured to accommodate the filter element material 206 of the filter element 202 to which the dust collection layer 202 is applied.

As the same with those shown in relation to FIG. 9, the filter element material 206, and thus the filter element 204 is also formed with at least one pocket-like or bag-like structure 310 having a pocket or bag shape.

The pocket-like or bag-like structure 310 defines the internal space 208 of the filter element material 206 or the filter element 204.

The internal space 208 is enclosed by at least one filter element wall 210 (see FIG. 12).

Therefore, the filter element 204 has an inner surface facing the internal space 208 and an outer surface facing in the opposite direction to the internal space 208.

In particular, the same filter element material 206 used in the example in FIG. 9 may also be used in the example in FIG. 11.

However, in the example in FIG. 11, the filter element material 206 is mounted to the mounting flange receiver 230 of the mounting flange 220 in a different orientation, i.e., an orientation such that at least one filter element wall 210 completely encloses the internal space 208, except for at least one raw material fluid inlet opening 228.

The raw material fluid inlet opening 228 is open towards the processing space 222.

Therefore, the aerosol (i.e., carrier fluid in which the powder mixture is dispersed, for example gas or air) in the processing space 222 flows into the internal space 208 of the filter element material 206 through the raw material fluid inlet opening 228.

When the filter element wall 210 is made of porous material (e.g., porous polyethylene), the fluid phase of the aerosol (e.g., gas or air) can pass through the filter element wall 210 and flow into a space 234 formed between the outer surface of the filter element material 206 and the mounting flange receiver 230.

The space 234 is in fluid communication with the fan, the blower, or the pump that draws the fluid out of the space 234 through a mounting flange outlet 238.

The mounting flange receiver 230, into which the filter element material 206 is inserted, is mounted into the mounting hole 216 as follows.

As shown in FIG. 11, the mounting hole 216 and the mounting flange 220 seal the processing space 222 airtight from the periphery of the processing box body housing 214. The mounting flange receiver 230 and the filter element material 206 seal the processing space 222 airtight against the space 234 formed between the outer side of the filter element material 206 and the mounting flange receiver 230. As a sealing means, a sealing means that is not in line with general engineering practice, for example a sealing ring, can also be used.

Therefore, in the configuration shown in FIG. 11, fluid passes through the filter element wall 210, as indicated by arrow B in FIG. 11, and after reaching the space 234 formed between the outside of the filter element material 206 and the mounting flange receiver 230, it can flow out of the processing space 222 only through the mounting flange outlet 238.

However, since the filter element wall 210 is not permeable to the powder material, the powder material cannot escape from the processing space 222 at all.

As the same with the orientation of the filter element 204 and the mounting flange 220 shown in FIG. 11, although only the fluid phase of the aerosol injected into the processing space 222 can pass through the filter element wall 210, the powder material (i.e., one or more kinds of fine particles dispersed in the carrier fluid injected through the inlet opening 218) cannot pass through the filter element wall 210, and thus the powder material adheres on the inside of the filter element material 206.

The adhesion of the powder on the inside of the filter element 204 helps to form the dust collection layer 202 on the inside of the filter element 204.

Therefore, in the processing box body 200 in FIG. 11, the pocket-like or bag-like filter element 204 is inserted into the processing box body 200 with the inside of the filter element 204 exposed to the processing space 222.

Therefore, the processing box body 200 in FIG. 11 is configured to form the dust collection layer 202 on the inside of the pocket-like filter element 204.

FIG. 12 shows a schematic cross-sectional view of the filter element produced by using the processing box body in FIG. 11.

The remaining process steps are the same as those described above with regard to the examples in FIGS. 9 and 10.

The dust collection layer 202 is secured to the filter element material 206 by referring to the above processes (i)-(iv) and the subsequent heating process.

### Example 6

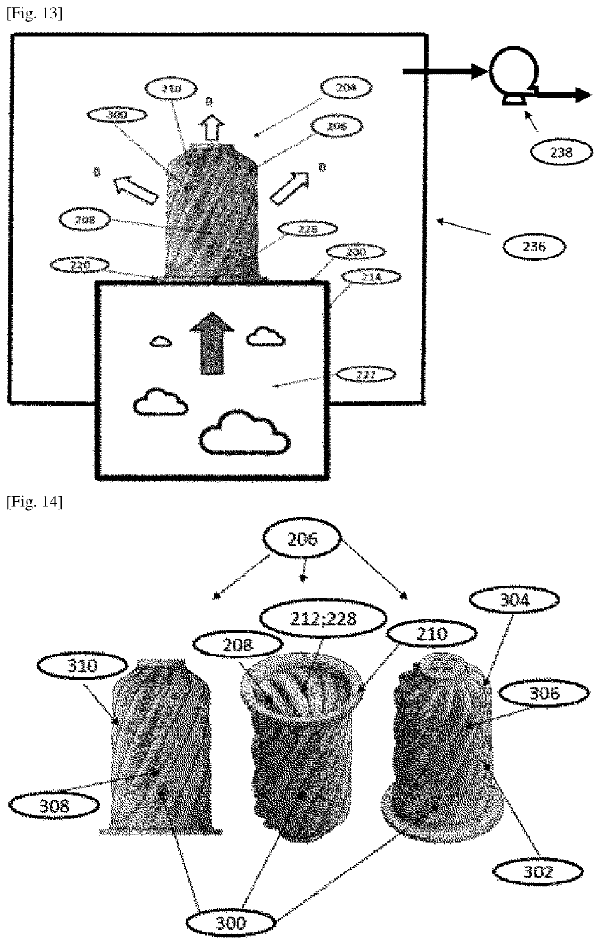

FIG. 13 shows a schematic view of the processing box body 200 configured to form the dust collection layer 202 on the pocket-like filter element 204 on the inside thereof, according to a further example.

FIG. 10 shows a schematic cross-sectional view of the filter element produced by using the processing box body in FIG. 13.

The processing box body in FIG. 13 basically corresponds to the processing box body in FIG. 11.

Therefore, the same reference numbers are also used in FIG. 13 as shown in FIG. 11.

Unless otherwise specified, it will be appreciated that components in FIG. 13 that have the same reference numbers as those shown in FIG. 11 are referred to the description in FIG. 11 above.

The differences between the examples in FIG. 11 and FIG. 13 will be described below.

As the same with those shown in relation to FIG. 11, the filter element material 206, and thus the filter element 204 is also formed with at least one pocket-like or bag-like structure 310 having a pocket or bag shape.

The pocket-like or bag-like structure 310 defines the inner space 208 of the filter element material 206 or the filter element 204.

The internal space 208 is enclosed by at least one filter element wall 210 (see FIG. 12).

Therefore, the filter element 204 has an inner surface facing the internal space 208 and an outer surface facing in the opposite direction to the internal space 208.

In particular, the same filter element material 206 as used in the examples in FIGS. 11 and 12 may also be used in the example in FIG. 13.

However, in the example in FIG. 13, the filter element material 206 is mounted to the mounting flange 220, i.e., from the outside of the processing box body housing 214, and in an orientation such that at least one filter element wall 210 completely encloses the internal space 208, except for at least one raw material fluid inlet opening 228.

The raw material fluid inlet opening 228 is open towards the processing space 222.

Therefore, an aerosol (i.e., carrier fluid, in which the powder mixture is dispersed, for example gas or air) in the processing space 222 can enter the internal space 208 of the filter element material 206 through the raw material fluid inlet opening 228.

Since the filter element wall 210 is made of porous material (e.g., porous polyethylene), the fluid phase of the aerosol (e.g., gas or air) can pass through the filter element wall 210 and flow into the external space outside the filter element 204.

From the external space outside the filter element 204, the fluid phase is sucked in by the action of a fan, a blower, or a pump that draws the fluid from the external space. For example, the processing box body housing 214 and the filter element 204 can be inserted into a second housing 236 coupled to the fan, the blower, or the pump.

The example in FIG. 13 does not require the mounting flange receiver 230 as described in relation to the example in FIG. 11.

In the processing chamber 290 in FIG. 13, the filter element 204 having a pocket or a bag shape is secured to the processing box body 200 by being fitted to the processing box body housing 214 so that the inside of the filter element 204 is exposed to the processing space 222, in the same way as the processing box body 200 in FIG. 11.

Therefore, the processing chamber 290 in FIG. 13 is configured to form the dust collection layer 202 inside the pocket-like filter element 204.

The remaining process steps are the same as those described above for the examples of FIGS. 11 and 12.

Referring to the above processes (i)-(v) and the subsequent heating process, the dust collection layer 202 is secured to the filter element material 206.

### Example 7

FIG. 14 shows three different perspective views of the filter element material 206 to which the dust collection layer 202 can be applied on the inside and/or the outside of the filter element material 206, in accordance with any one of examples according to the present invention.

The filter element material 206, and thus the filter element 204 is also formed with the pocket-like or bag-like structure 310 having a pocket or bag shape.

The pocket-like or bag-like structure 310 defines the internal space 208 of the filter element material 206 or the filter element 204.

The internal space 208 is enclosed by at least one filter element wall 210 (see FIG. 10 or 12).

Therefore, the filter element 204 or the filter element material 206 has an inside facing the internal space 208 and an outside facing in the opposite direction to the internal space 208.

As described in Example 4, the dust collection layer 202 can be formed on the outer surface of the filter element material 206 to produce the filter element having the dust collection layer 202 on the outer surface thereof.

Alternatively or additionally, as described with respect to Examples 5 and 6, the dust collection layer 202 may be formed on the inside of the filter element material 206 to produce the filter element having the dust collection layer 202 on the inside thereof.

The filter element material 206 is formed with at least one filter element wall 210 defining the lamella structure 300.

The lamella structure 300 includes a complex geometric configuration of the convex portion 304 and the concave portion 306 on the outside of at least one filter element wall 210.

Alternatively, the lamella structure 300 includes a complex geometric configuration of the convex portion 304 and the concave portion 306 and may include at least one concave portion 306 on the inside of at least one filter element wall 210.

In particular, as shown in FIG. 14, the lamellar structure 300 includes a complementary geometric configuration including a plurality of the convex portions 304 and the concave portions 306 on both the outside and inside of at least one filter element wall 210.

The convex portion 304 and the concave portion 306 of at least one filter element wall 210 are shaped to form at least one undercut portion 308 of the geometric configuration.

A particular advantage of the filter element wall 210 defining the lamellar structure 300 is that it allows to provide a relatively large filter surface area for a given volume of the filter element material 206.

However, it is usually difficult to apply the dust collection layer to such a surface of the filter element material 206, especially when the lamellar structure 300 includes an undercut portion 308 or when it has a plurality of undercut portions 308.

Conventional coating methods have not been able to form the sufficiently uniform dust collection layer 202 on the filter element material 206 having such a complex geometric configuration.

However, a dry coating method according to the present invention has provided for the first time a method for forming the sufficiently uniform dust collection layer 202 on the filter element material 206 having a complex geometric configuration, such as the lamella structure 300 having the convex portion 304 and the concave portion 306 having at least one undercut portion 308, as described herein.

In the specific example shown in FIG. 14, the geometric configuration of the lamellar structure includes the helical structure 302.

The convex portion 304 and the concave portion 306 of at least one filter element wall 210 are shaped to form the helical structure of the lamellar structure.

The filter element material 206, and thus the filter element 204 are also formed with at least one pocket-like or bag-like structure 310 having a cylindrical shape.

In another example, the filter element material 206, and thus the filter element 204 can also be formed to have a cone, a truncated cone, or other rotationally symmetric shape defined by at least one filter element wall 210.

The term “rotationally symmetric shape” is intended to indicate any shapes having a rotational symmetry along the vertical axis of the filter element material 206.

The filter element material 206 having such a complex geometric shape can be produced by a sintering process, for example, by sintering polymer particles, particularly polyethylene particles.

### Example 8

FIG. 15 shows a different view of the additional filter element material 206, in which the dust collection layer 202 can be formed on the inside and/or the outside of the filter element material 206, in accordance with any one of examples according to the present invention.

In the example in FIG. 15, the filter element material 206, and thus the filter element 204 are also formed with a plurality of pocket-like or bag-like structures 310.

Each of these pocket-like or bag-like structures 310 has a pocket or bag shape.

The pocket-like or bag-like structure 310 divides the internal space 208 of the filter element material 206 or the filter element 204.

The internal space 208 is enclosed by at least one filter element wall 210.

Therefore, the filter element 204 or the filter element material 206 has an inner surface facing the inner space 208 and an outer surface facing in the opposite direction to the inner space 208.

The above matters to be considered described in relation to FIG. 14 also apply in relation to the example in FIG. 15. Therefore, it will be appreciated that these considerations are also referred.

### Example 9

In accordance with Example 4, a filter element was produced by subjecting a cylindrical filter element material to a process of forming a dust collection layer in a processing box body.

Next, a dust collection load confirmation test was conducted to this filter element by using the dust collection load test device in FIG. 7.

The filter element material was produced by sintering polyethylene particles.

The filter element material had a cylindrical shape having a filter element wall that was almost cylindrical.

The filter element wall, which was approximately cylindrical, was provided with a lamella structure having a helical shape.

The lamella structure was formed with a plurality of helical convex and concave portions, as shown in FIG. 14.

The filter element body had a diameter of 137 mm and a length of 220 mm.

After inserting the filter element body into the processing chamber in FIG. 14, a fine particle mixture was flowed into the processing box body to form a dust collection layer on the filter element body.

The mixture of fine particles was made of 60% by weight of LLDPE (linear low-density polyethylene, D50=45 μm) and 40% by weight of UHMWPE (ultra-high-molecular-weight polyethylene, D50=10 μm).

The mixture did not contain PTFE.

The processing steps followed the steps described in relation to Example 1 and the description above in relation to Example 4.

The produced filter element had a filtration surface of 0.15 m².

The filter element was inserted into the dust load collection test device in FIG. 7.

The test parameters were as follows:
Filter surface: 0.15 m²
Dust collection load: 1.5 kg clay slate,
equivalent to 2.01 in volume
Air flow: 107.1 m³/s (start of test)-84 m³/s (end of test)
Mass flow of dust: 60 g/s
Feed concentration of dust: 2017.0 g/m³
Pulse cleaning cycle: 28 seconds
Pulse cleaning duration: 2 seconds
Pressure of cleaning pulse: 0.9 bar
Test period: 2880 cycles=191 hours
Total amount of dust conveyed: 34380 kg

The pressure loss of the filter element after the pressure cleaning cycle was as follows.
Initial pressure loss: 1750 Pa
Pressure loss after 5 minutes: 2650 Pa
Pressure loss after 30 minutes: 2800 Pa
Pressure loss after 1 hour: 3600 Pa
Pressure loss after 2 hours: 3850 Pa
Pressure loss after 17 hours: 5450 Pa
Pressure loss after 41 hours: 6150 Pa
Pressure loss after 43 hours: 6150 Pa
Pressure loss after 67 hours: 6400 Pa
Pressure loss after 89 hours: 6600 Pa
Pressure loss after 161 hours: 6600 Pa
Pressure loss after 185 hours: 6600 Pa
Pressure loss after 191 hours: 6600 Pa

The above pressure loss over time is graphed and shown in FIG. 16.

The maximum dust concentration measured in the clean gas downstream of the filter element was as follows:
10 minutes later: 0.099 mg/m²
1 hour later: 0.071 mg/m²
43 hours later: 0.099 mg/m² The dust concentration was measured by using Hund (registered trademark) Data II device manufactured by Helmut Hund GmbH at Wetzlar, Germany.

After dismantling the filter element from the dust collection load test device, no traces of the dust substances contaminated in the material of the filter element was found.

### REFERENCE SIGNS LIST

10 sintered lamellar dust collector
12 casing
14 upper top panel
16 dust collection chamber
18 clean air chamber
20 supply port for dust-containing air
22 exhaust port for the clean air
24 filter element
24a hollow chamber
26 hopper
28 outlet for dust
32 large diameter part
34 frame
36 fastening bolt
38 packing
91 aerosol blowoff port
92 compressed air blowoff port
93 dust collection layer composition powder
100 fan
101 quantitative supply device
102 upper tank
103 upper clean air chamber
104 dust conveyance device
105 lower tank
106 testing filter element
107 lower dust collection chamber
108 upper top plate
109 hopper
200 processing box body
202 dust collection layer
204 filter element
206 filter element material
208 internal space
210 filter element wall
212 clean air outlet
214 processing box body housing
216 mounting hole
218 inlet opening
220 mounting flange
222 processing space
226 nozzle device
228 raw material fluid inlet opening
230 mounting flange receiver
234 space between filter element and mounting flange receiver
236 second housing
238 mounting flange outlet
290 the processing chamber
300 lamellar structure
302 helical structure
304 convex portion
306 concave portion
308 undercut portion
310 pocket-like or bag-like structure

1. A method for producing a filter element, comprising:
mixing two or more kinds of fine particles sufficiently;
forming a layer made of the two or more kinds of fine particles on a surface of a filter element material;
heating by using a heater to melt one or more kinds of fine particles of the fine particles; and
forming a dust collection layer after cooling;
wherein a softening point of one or more kinds of fine particles of the two or more kinds of fine particles is lower than a softening point of other fine particles and particles constituting the filter element material.

2. The method for producing a filter element according to claim 1, wherein a particle diameter of one or more kinds of fine particles of the two or more kinds of fine particles is/are smaller than a particle diameter of resin constituting the filter element material.

3. The method for producing a filter element according to claim 1, wherein the two or more kinds of fine particles are sufficiently mixed in advance and then sucked onto the filter element material to form the filter element on a surface of the filter element material.

4. The method for producing a filter element according to claim 1, wherein the two or more kinds of fine particles are separately sucked onto the filter element material to form the filter element in a layered form on a surface of the filter element material.

5. The method for producing a filter element according to claim 1, wherein in the heating the heater comprises an infrared heater or oven.

6. The method for producing a filter element according to claim 1, wherein the filter element comprises at least one pocket-like or bag-like structure;
the at least one pocket-like or bag-like structure has an internal space enclosed by at least one wall of the filter element, leaving at least one clean fluid outlet opening; and
the filter element has an inner surface facing the internal space) and an outer surface oriented in an opposite direction to the internal space, and a dust collection layer is formed on the outer surface of the filter element.

7. The method for producing a filter element according to claim 1, wherein the filter element comprises at least one pocket-like or bag-like structure;
the at least one pocket-like or bag-like structure has an internal space enclosed by at least one wall of the filter element, leaving at least one unprocessed fluid inlet opening;
the filter element has an inner surface facing the internal space and an outer surface facing in an opposite direction to the internal space; and
a dust collection layer is formed on the inner surface of the filter element.

8. The method for producing a filter element according to claim 1, wherein the filter element is formed with at least one filter element wall defining a lamellar structure; and the lamellar structure comprises a geometric configuration having a convex portion and a concave portion on at least one of two opposite sides of the at least one filter element wall.

9. The method for producing a filter element according to claim 8, wherein the geometric configuration comprises a plurality of convex portions and concave portions on both sides of the at least one filter element wall.

10. The method for producing a filter element according to claim 8, wherein the convex portion and the concave portion of the at least one filter element wall are shaped to form at least one undercut portion of the geometric configuration.

11. The method for producing a filter element according to claim 8, wherein the geometric configuration of the lamellar structure comprises a helical structure.

12. The method for producing a filter element according to claim 8, wherein the filter element is formed with at least one pocket-like or bag-like structure having a cylindrical, conical, or other rotational symmetric shape defined by the at least one filter element wall; and
the convex portion and the concave portion of the at least one filter element wall are shaped to form the geometric configuration of the lamellar structure.

13. The method for producing a filter element according to claim 1, wherein one of the two or more kinds of fine particles constitutes a matrix material of the dust collection layer and is made of a same resin material as the filter element material.

14. The method for producing a filter element according to claim 13, wherein one of two kinds of fine particles constituting the matrix material of the dust collection layer comprises polyethylene.

15. The method for producing a filter element according to claim 1, wherein the dust collection layer is formed without using any binder or solvents.

16. The method for producing a filter element according to claim 1, wherein the two or more kinds of fine particles do not include perfluoroalkoxy alkane (PFA).

17. A filter element produced by using the method according to claim 1.

18. The method for producing a filter element according to claim 1, wherein the two or more kinds of fine particles are dry particles.
